(19) United States
(12) Patent Application Publication
(10) Pub. No.: US 2026/0229183 A1
(43) Pub. Date: Aug. 6, 2026

(54) DISPLAY PANEL AND DISPLAY APPARATUS

(71) Applicant: Wuhan Tianma Microelectronics Co., Ltd., Wuhan (CN)

(72) Inventor: Wanrong LI, Wuhan (CN)

(73) Assignee: Wuhan Tianma Microelectronics Co., Ltd., Wuhan, HB (CN)

(21) Appl. No.: 19/571,173

(22) Filed: Mar. 18, 2026

(30) Foreign Application Priority Data
Oct. 31, 2025 (CN) 202511589427.4

(51) Int. Cl. G09G 3/3233

(52) U.S. Cl. CPC G09G 3/3233; G09G 2300/0426; G09G 2300/0452; G09G 2300/0842; G09G 2300/0861; G09G 2320/0233

(57) ABSTRACT

Provided are a display panel and a display apparatus. The display panel includes: a plurality of repeating units arranged in an array, wherein a repeating unit includes first and second sub-units arranged along a column direction, the first sub-unit includes first, second, third, and second color light-emitting elements arranged in sequence along a row direction, and the second sub-unit includes third, second, first, and second color light-emitting elements that are arranged in sequence along the row direction; wherein the first color light-emitting elements in an i-th column of light-emitting elements are electrically connected to the first pixel circuits in a (j+1)-th column of pixel circuits respectively; and the first color light-emitting elements in an (i+2)-th column of light-emitting elements are electrically connected to the first pixel circuits in a (j+2)-th column of pixel circuits respectively. The present disclosure is conducive to improving the display effect.

### CROSS-REFERENCE TO RELATED APPLICATION

The present disclosure claims priority to Chinese Patent Application No. 202511589427.4, filed on Oct. 31, 2025, the content of which is incorporated herein by reference in its entirety.

### TECHNICAL FIELD

The present disclosure relates to the field of display technologies, and in particular, to a display panel and a display apparatus.

### BACKGROUND

With the development of display technologies, electronic products with a display function, such as mobile phones, computers, televisions and the like, play an increasingly important role and have gradually become necessities in people's life and work. In these products, the display quality directly affects the quality of image display.

To implement high-frequency driving of a display panel, a double-data line type display panel has been proposed in the related art, that is, pixels in a same column are connected to two data lines. Meanwhile, to facilitate the connection between pixel circuits and the data lines, channels of transistors with a same function in some pixel circuits are disposed at different positions in the corresponding pixel circuits. However, with such an arrangement, during the manufacturing process of the display panel, when patterns between different photolithography layers are not precisely aligned and misalignment occurs, changes in the potentials of at least some nodes in some pixel circuits are caused to be different, resulting in the problem of non-uniform display.

### SUMMARY

In order to solve the above technical problem or at least partially solve the above technical problem, the present disclosure provides a display panel and a display apparatus, which are conducive to improving the display effect.

In an aspect, the present disclosure provides a display panel, including: a substrate; a plurality of pixel circuits arranged in an array, where a pixel circuit of the plurality of pixel circuits includes a plurality of transistors, a transistor of the plurality of transistors includes a channel, the pixel circuits include first pixel circuits and second pixel circuits, the first pixel circuits and the second pixel circuits are alternately arranged along a row direction, the first pixel circuits and the second pixel circuits are alternately arranged along a column direction, and channels of at least two transistors in a first pixel circuit of the first pixel circuits and channels of at least two transistors in a second pixel circuit of the second pixel circuits are mirror-symmetric with respect to the column direction, where the row direction intersects with the column direction; a plurality of light-emitting elements, where the light-emitting elements include first color light-emitting elements, second color light-emitting elements, and third color light-emitting elements with different emission colors; a plurality of repeating units arranged in an array, where a repeating unit of the plurality of repeating units includes a first sub-unit and a second sub-unit arranged along the column direction, the first sub-unit includes a first color light-emitting element, a second color light-emitting element, a third color light-emitting element, and a second color light-emitting element that are arranged in sequence along the row direction, and the second sub-unit includes a third color light-emitting element, a second color light-emitting element, a first color light-emitting element, and a second color light-emitting element that are arranged in sequence along the row direction; where the first color light-emitting elements in an i-th column of light-emitting elements are electrically connected to the first pixel circuits in a (j+1)-th column of pixel circuits respectively; and the first color light-emitting elements in an (i+2)-th column of light-emitting elements are electrically connected to the first pixel circuits in a (j+2)-th column of pixel circuits respectively.

In some embodiments, the present disclosure further provides a display apparatus including a above-mentioned display panel, wherein display panel includes: a substrate; a plurality of pixel circuits arranged in an array, wherein a pixel circuit of the plurality of pixel circuits includes a plurality of transistors, a transistor of the plurality of transistors includes a channel, the pixel circuits include first pixel circuits and second pixel circuits, the first pixel circuits and the second pixel circuits are alternately arranged along a row direction, the first pixel circuits and the second pixel circuits are alternately arranged along a column direction, and channels of at least two transistors in a first pixel circuit of the first pixel circuits and channels of at least two transistors in a second pixel circuit of the second pixel circuits are mirror-symmetric with respect to the column direction, wherein the row direction intersects with the column direction; a plurality of light-emitting elements, wherein the light-emitting elements include first color light-emitting elements, second color light-emitting elements, and third color light-emitting elements with different emission colors; a plurality of repeating units arranged in an array, wherein a repeating unit of the plurality of repeating units includes a first sub-unit and a second sub-unit arranged along the column direction, the first sub-unit includes a first color light-emitting element, a second color light-emitting element, a third color light-emitting element, and a second color light-emitting element that are arranged in sequence along the row direction, and the second sub-unit includes a third color light-emitting element, a second color light-emitting element, a first color light-emitting element, and a second color light-emitting element that are arranged in sequence along the row direction, wherein the first color light-emitting elements in an i-th column of light-emitting elements are electrically connected to the first pixel circuits in a (j+1)-th column of pixel circuits respectively; and the first color light-emitting elements in an (i+2)-th column of light-emitting elements are electrically connected to the first pixel circuits in a (j+2)-th column of pixel circuits respectively.

### BRIEF DESCRIPTION OF DRAWINGS

The accompanying drawings herein are incorporated into and constitute a part of this specification, show embodiments consistent with the present disclosure, and together with the specification, serve to explain the principles of the present disclosure.

To more clearly illustrate the technical solutions in the embodiments of the present disclosure or the related art, the accompanying drawings used in the description of the embodiments or the related art will be briefly introduced below. It should be understood that, for those of ordinary skill in the art, other drawings can also be obtained according to the present disclosure.

FIG. 1 is a schematic plan view of a display panel according to the present disclosure;

FIG. 2 is an equivalent circuit diagram of a pixel circuit according to the present disclosure;

FIG. 3 is a schematic diagram of a layout structure of the display panel shown in FIG. 1;

FIG. 4 is a schematic diagram of a layout structure of a semiconductor layer according to the present disclosure;

FIG. 5 is a schematic diagram of a layout structure of a first metal layer according to the present disclosure;

FIG. 6 is a schematic diagram of a layout structure of a second metal layer according to the present disclosure;

FIG. 7 is a schematic diagram of a layout structure of a third metal layer according to the present disclosure;

FIG. 8 is another schematic plan view of the display panel shown in FIG. 1;

FIG. 9 is a schematic diagram of another layout structure of the display panel shown in FIG. 1;

FIG. 10 is a schematic plan view of a display panel illustrated in the related art;

FIG. 11 is a schematic diagram of another layout structure of the display panel shown in FIG. 1;

FIG. 12 is a schematic diagram of a layout structure of another second metal layer according to the present disclosure;

FIG. 13 is a schematic diagram of a layout structure of another third metal layer according to the present disclosure;

FIG. 14 is still another schematic plan view of the display panel shown in FIG. 1;

FIG. 15 is still another schematic plan view of the display panel shown in FIG. 1; and

FIG. 16 is a schematic plan view of a display apparatus according to the present disclosure.

### DESCRIPTION OF EMBODIMENTS

In order to be able to more clearly understand the above objectives, features and advantages of the present disclosure, the solutions of the present disclosure will be further described below. It should be noted that the embodiments of the present disclosure and the features in the embodiments may be combined with each other without conflict.

In the following description, numerous specific details are set forth for the purpose of fully understanding the present disclosure, but the present disclosure may also be implemented in other manners different from those described herein. The embodiments in the specification are merely some of the embodiments of the present disclosure, rather than all of the embodiments.

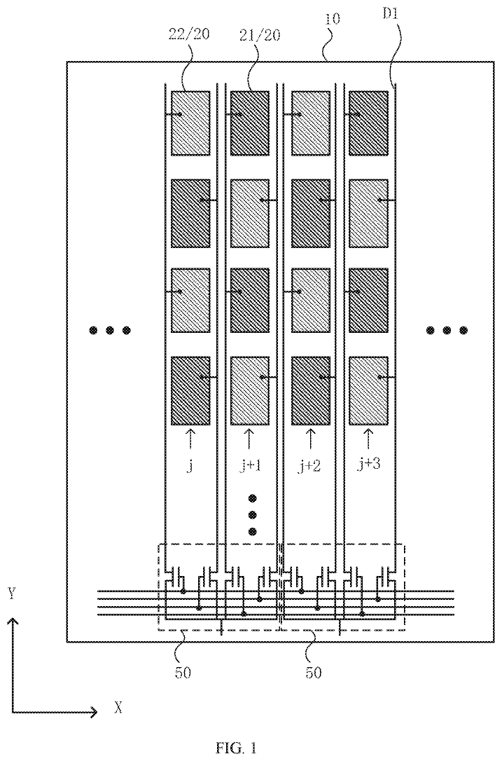

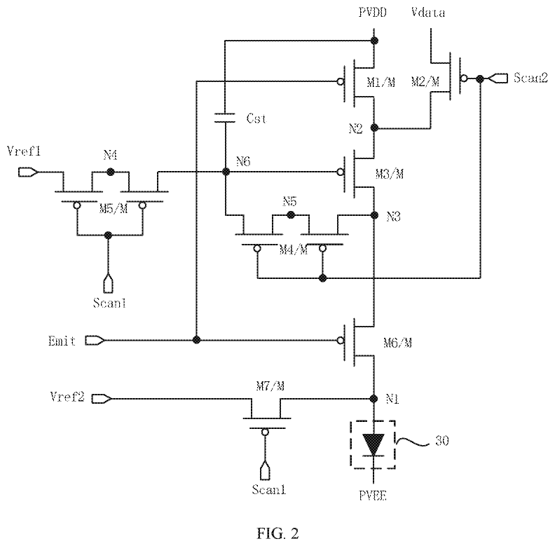

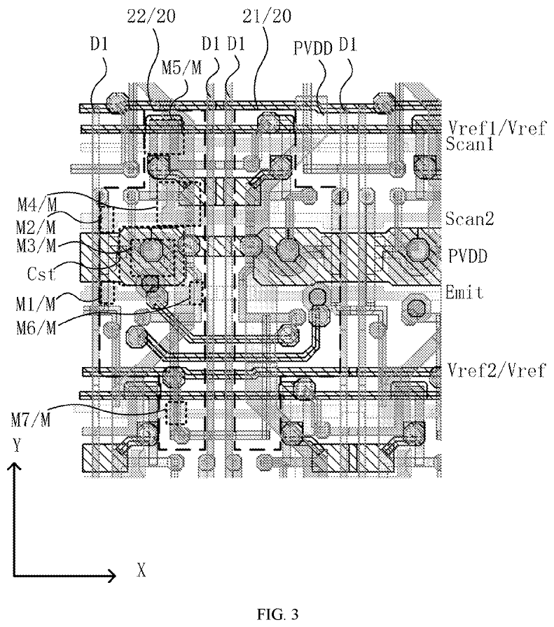

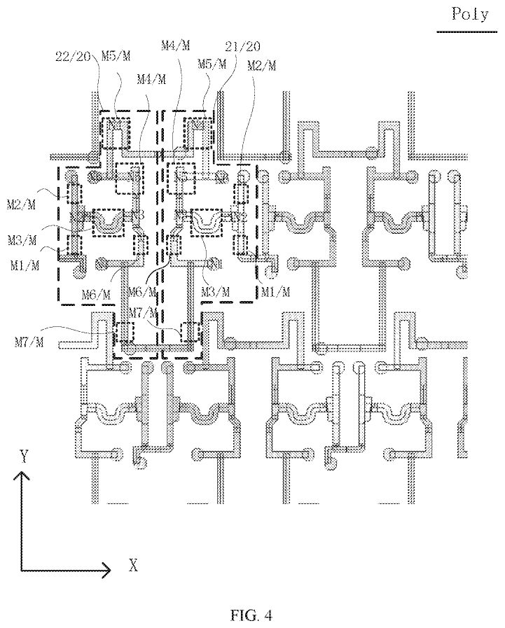

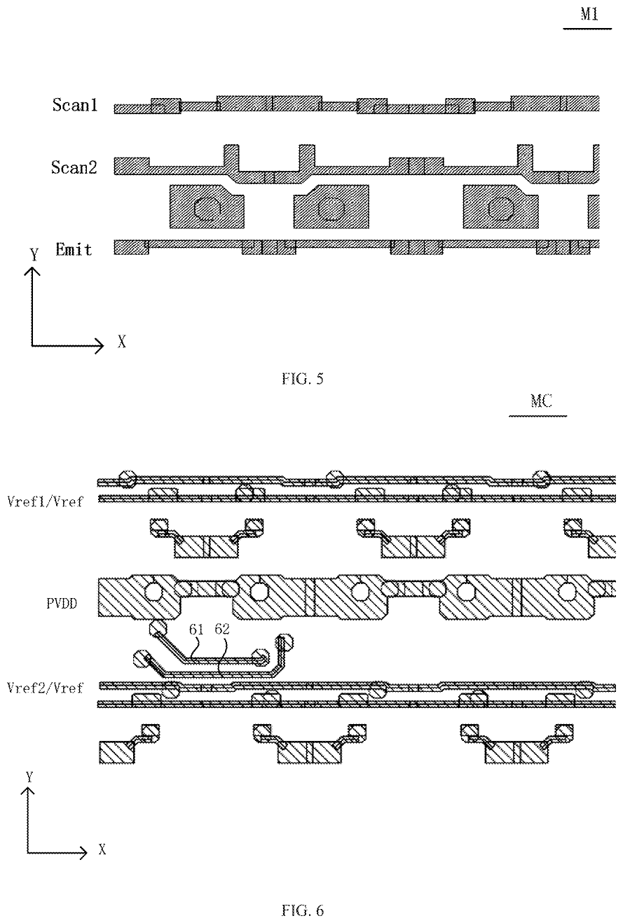

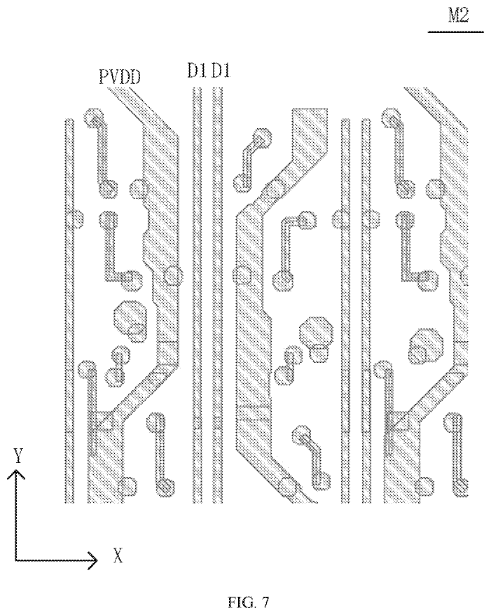

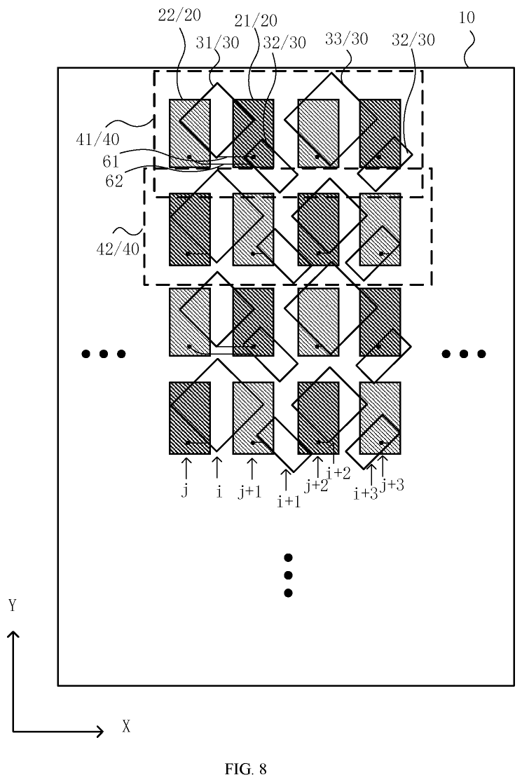

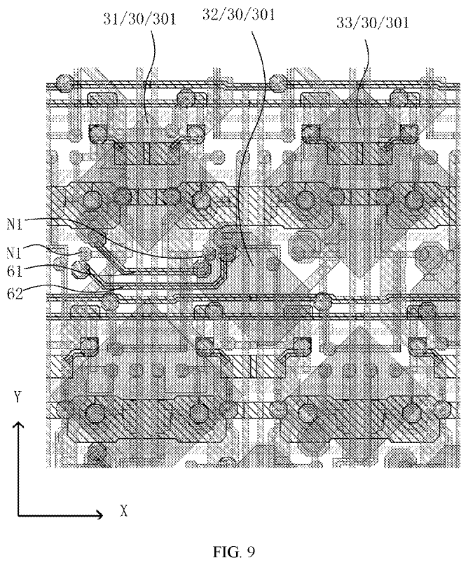

FIG. 1 is a schematic plan view of a display panel according to the present disclosure. FIG. 2 is an equivalent circuit diagram of a pixel circuit according to the present disclosure. FIG. 3 is a schematic diagram of a layout structure of the display panel shown in FIG. 1. FIG. 4 is a schematic diagram of a layout structure of a semiconductor layer according to the present disclosure. FIG. 5 is a schematic diagram of a layout structure of a first metal layer according to the present disclosure. FIG. 6 is a schematic diagram of a layout structure of a second metal layer according to the present disclosure. FIG. 7 is a schematic diagram of a layout structure of a third metal layer according to the present disclosure. FIG. 8 is another schematic plan view of the display panel shown in FIG. 1. FIG. 9 is a schematic diagram of another layout structure of the display panel shown in FIG. 1. It should be noted that the light-emitting elements are not shown in FIGS. 1 and 4 for the purpose of clearly illustrating the structure of the pixel circuits, and the structure of the light-emitting elements may be referred to in FIGS. 8 and 9.

With reference to FIGS. 1 to 9, an embodiment of the present disclosure provides a display panel, including:
a substrate 10;
a plurality of pixel circuits 20 arranged in an array, where a pixel circuit 20 of the plurality of pixel circuits 20 includes a plurality of transistors M, a transistor M of the plurality of transistors M includes a channel, the pixel circuits 20 include first pixel circuits 21 and second pixel circuits 22, the first pixel circuits 21 and the second pixel circuits 22 are alternately arranged along a row direction X, the first pixel circuits 21 and the second pixel circuits 22 are alternately arranged along a column direction Y, and channels of at least two transistors M in a first pixel circuit 21 of the first pixel circuits 21 and channels of at least two transistors M in a second pixel circuit 22 of the second pixel circuits 22 are mirror-symmetric with respect to the column direction Y, where the row direction X intersects with the column direction Y;
a plurality of light-emitting elements 30, where the light-emitting elements 30 include first color light-emitting elements 31, second color light-emitting elements 32, and third color light-emitting elements 33 with different emission colors;
a plurality of repeating units 40 arranged in an array, where a repeating unit 40 of the plurality of repeating units 40 includes a first sub-unit 41 and a second sub-unit 42 arranged along the column direction Y, the first sub-unit 41 includes a first color light-emitting element 31, a second color light-emitting element 32, a third color light-emitting element 33, and a second color light-emitting element 32 that are arranged in sequence along the row direction X, and the second sub-unit 42 includes a third color light-emitting element 33, a second color light-emitting element 32, a first color light-emitting element 31, and a second color light-emitting element 32 that are arranged in sequence along the row direction X; where
the first color light-emitting elements 31 in an i-th column of light-emitting elements 30 are electrically connected to the first pixel circuits 21 in a (j+1)-th column of pixel circuits 20 respectively; and
the first color light-emitting elements 31 in an (i+2)-th column of light-emitting elements 30 are electrically connected to the first pixel circuits 21 in a (j+2)-th column of pixel circuits 20 respectively.

Specifically, the display panel according to this embodiment includes a substrate 10. Optionally, the substrate 10 may be a rigid substrate or a flexible substrate. The rigid substrate may be, but is not limited to, one or more of glass and metal foil. The flexible substrate may be, but is not limited to, one or more of polyethylene terephthalate, ethylene terephthalate, polyether ether ketone, polystyrene, polycarbonate, polyarylate, polyaryl ester, polyimide, polyvinyl chloride, polyethylene, and textile fiber.

The display panel further includes a plurality of pixel circuits 20 arranged in an array, where a pixel circuit 20 of the plurality of pixel circuits 20 includes a plurality of transistors M, and a transistor M of the plurality of transistors M includes a channel.

In some embodiments, the pixel circuit 20 may be a 7T1C circuit. The pixel circuit 20 may include a first transistor M1 to a seventh transistor M7, and a storage capacitor Cst. Herein, a gate of the first transistor M1 is electrically connected to a light-emitting control signal line Emit, a first electrode of the first transistor M1 is electrically connected to a first power supply signal line PVDD, and a second electrode of the first transistor M1 is electrically connected to a second node N2. A gate of the second transistor M2 is electrically connected to a second scan signal line Scan2, a first electrode of the second transistor M2 is electrically connected to a data line D1, and a second electrode of the second transistor M2 is electrically connected to the second node N2. A gate of the third transistor M3 is electrically connected to a sixth node N6, a first electrode of the third transistor M3 is electrically connected to the second node N2, and a second electrode of the third transistor M3 is electrically connected to a third node N3. A gate of the fourth transistor M4 is electrically connected to the second scan signal line Scan2, a first electrode of the fourth transistor M4 is electrically connected to the third node N3, and a second electrode of the fourth transistor M4 is electrically connected to the sixth node N6. A gate of the fifth transistor M5 is electrically connected to a first scan signal line Scan1, a first electrode of the fifth transistor M5 is electrically connected to a first reference voltage signal line Vref1, and a second electrode of the fifth transistor M5 is electrically connected to the sixth node N6. A gate of the sixth transistor M6 is electrically connected to the light-emitting control signal line Emit, a first electrode of the sixth transistor M6 is electrically connected to the third node N3, and a second electrode of the sixth transistor M6 is electrically connected to the first node N1. A gate of the seventh transistor M7 is electrically connected to the first scan signal line Scan1, a first electrode of the seventh transistor M7 is electrically connected to a second reference voltage signal line Vref2, and a second electrode of the seventh transistor M7 is electrically connected to a first node N1. A first electrode of the storage capacitor Cst is electrically connected to the first power supply signal line PVDD, and a second electrode of the storage capacitor Cst is electrically connected to the sixth node N6. The first node N1 is electrically connected to a light-emitting element 30.

In some embodiments, the third transistor M3 is a driving transistor, and the other transistors are all switch transistors. The first transistor M1 to the seventh transistor M7 may all be P-type transistors or N-type transistors, which is not specifically limited in the present disclosure.

Taking that the first transistor M1 to the seventh transistor M7 are all P-type transistors as an example, an operating process of the pixel circuit may include a reset phase, a data writing phase, and a light-emitting control phase.

In the reset phase, the first scan signal line Scan1 provides an active level, the fifth transistor M5 and the seventh transistor M7 are turned on, and initial signals provided by the first reference voltage signal line Vref1 and the second reference voltage signal line Vref2 reset the sixth node N6 and the first node N1 respectively.

In the data writing phase, the second scan signal line Scan2 provides an active level, the second transistor M2 and the fourth transistor M4 are turned on, a data signal is written to the second node N2, and a potential of a signal at the sixth node N6 is made the same as a potential of a signal at the third node N3, whereby the third transistor M3 is turned on.

In the light-emitting control phase, the light-emitting control signal line Emit provides an active level, the first transistor M1 and the sixth transistor M6 are turned on, and the third transistor M3 provides a driving current to drive the light-emitting element 30 to emit light.

The display panel according to some embodiments of the present disclosure includes the first scan signal line Scan1, the second scan signal line Scan2, the first reference voltage signal line Vref1, the second reference voltage signal line Vref2, the data line D1, the first power supply signal line PVDD, the light-emitting control signal line Emit, and sub-pixels. Each sub-pixel includes a light-emitting element 30 and a pixel circuit 20 configured to drive the light-emitting element 30 to emit light, where the pixel circuit 20 includes a plurality of transistors M.

It should be noted that the present disclosure, in some embodiments, shows that the pixel circuit 20 may be a 7T1C circuit, and in other embodiments of the present disclosure, the pixel circuit 20 may also adopt other circuits, which is not further elaborated herein in the present disclosure.

The display panel further includes a semiconductor layer Poly, a first metal layer M1, a second metal layer MC, and a third metal layer M2 which are provided in sequential on the substrate 10 and insulated from each other. Herein, the semiconductor layer Poly includes the channel of each transistor M, the first metal layer M1 includes the first scan signal line Scan1, the second scan signal line Scan2, the light-emitting control signal line Emit, and the first electrode of the storage capacitor Cst, the second metal layer MC includes the first reference voltage signal line Vref1, the second reference voltage signal line Vref2, a part of the first power supply signal line PVDD, and the second electrode of the storage capacitor Cst, and the third metal layer M2 includes a source and a drain of each transistor M, the data line D1, and a part of the first power supply signal line PVDD.

It should be noted that in other embodiments of the present disclosure, the source and drain of each transistor M may be provided in a different film layer from the data line D1 and a part of the first power supply signal line PVDD, that is, the source and drain of each transistor M may be provided in the third metal layer M2, and the data line D1 and a part of the first power supply signal line PVDD may be provided in another metal layer, which is not elaborated one by one herein in the present disclosure.

The pixel circuits 20 include first pixel circuits 21 and second pixel circuits 22, channels of at least two transistors M in a first pixel circuit 21 of the first pixel circuits 21 and channels of at least two transistors M in a second pixel circuit 22 of the second pixel circuits 22 are mirror-symmetric with respect to the column direction Y. That is, the channels of some transistors M in the first pixel circuit 21 and the channels of some transistors M in the second pixel circuit 22 are mirror structures of each other with respect to the column direction Y. In some embodiments, with reference to FIG. 4, when the pixel circuit 20 is a 7T1C circuit, the channel of the third transistor M3 in the first pixel circuit 21 and the channel of the third transistor M3 in the second pixel circuit 22 are symmetric with respect to a first symmetry axis (extending along the column direction, not shown in the figure), and the channel of the second transistor M2 in the first pixel circuit 21 and the channel of the second transistor M2 in the second pixel circuit 22 are symmetric with respect to a second symmetry axis (extending along the column direction, not shown in the figure), where the first symmetry axis and the second symmetry axis may or may not coincide with each other. It can be understood that the first transistor M1 and the fourth transistor M4 to the seventh transistor M7 in the first pixel circuit 21 may be mirror-symmetric with respect to the column direction Y with the first transistor M1 and the fourth transistor M4 to the seventh transistor M7 in the second pixel circuit 22 respectively. Certainly, in the first pixel circuit 21 and the second pixel circuit 22, except that the channels of some or all transistors M are mirror structures of each other, overall structures of some transistors M may also be mirror structures of each other with respect to the column direction Y. Alternatively, the channel of each transistor M in the first pixel circuit 21 and the channel of each transistor M in the second pixel circuit 22 are all mirror-symmetric with respect to the column direction Y.

The first pixel circuits 21 and the second pixel circuits 22 are arranged alternately along the row direction X, and the first pixel circuits 21 and the second pixel circuits 22 are arranged alternately along the column direction Y, where the row direction X intersects with the column direction Y. Optionally, the row direction X and the column direction Y are perpendicular to each other.

The display panel further includes a plurality of light-emitting elements 30, the light-emitting elements 30 include first color light-emitting elements 31, second color light-emitting elements 32, and third color light-emitting elements 33, and light-emitting colors of the first color light-emitting elements 31, the second color light-emitting elements 32, and the third color light-emitting elements 33 are different. Optionally, the first color light-emitting elements 31 are red light-emitting elements, the second color light-emitting elements 32 are green light-emitting elements, the third color light-emitting elements 33 are blue light-emitting elements, the light-emitting color of the red light-emitting elements is red, the light-emitting color of the green light-emitting elements is green, and the light-emitting color of the blue light-emitting elements is blue. Certainly, in other embodiments of the present disclosure, the first color light-emitting elements 31, the second color light-emitting elements 32, and the third color light-emitting elements 33 may also be light-emitting elements of other colors, which is not elaborated one by one herein in the present disclosure.

The display panel further includes a plurality of repeating units 40 arranged in an array. A repeating unit 40 of the plurality of repeating units 40 includes a first sub-unit 41 and a second sub-unit 42 arranged along the column direction Y. Herein, the first sub-unit 41 includes a first color light-emitting element 31, a second color light-emitting element 32, a third color light-emitting element 33, and a second color light-emitting element 32 that are arranged in sequence along the row direction X. The second sub-unit 42 includes a third color light-emitting element 33, a second color light-emitting element 32, a first color light-emitting element 31, and a second color light-emitting element 32 that are arranged in sequence along the row direction X.

Optionally, in the first sub-unit 41, any two adjacent light-emitting elements 30 at least partially overlap along the row direction X; and in the second sub-unit 42, any two adjacent light-emitting elements 30 at least partially overlap along the row direction X. That is, the first sub-unit 41 includes the first color light-emitting element 31, the second color light-emitting element 32, the third color light-emitting element 33, and the second color light-emitting element 32 arranged in sequence, and in a same first sub-unit 41, each light-emitting element 30 at least partially overlaps with an adjacent light-emitting element 30 along the row direction X. Similarly, the second sub-unit 42 includes the third color light-emitting element 33, the second color light-emitting element 32, the first color light-emitting element 31, and the second color light-emitting element 32 arranged in sequence, and in a same second sub-unit 42, each light-emitting element 30 at least partially overlaps with an adjacent light-emitting element 30 along the row direction X.

It should be noted that some light-emitting elements 30 arranged along the row direction X can be understood as that along the row direction X, the some light-emitting elements 30 at least partially overlap. When there exist some light-emitting elements 30 each partially overlapping with other light-emitting elements 30 in two rows along the row direction X, some light-emitting elements 30 arranged along the row direction X can be understood as that along the row direction X, the some light-emitting elements 30 at least partially overlap, and the pixel circuits 20 electrically connected to the some light-emitting elements 30 are arranged along the row direction X.

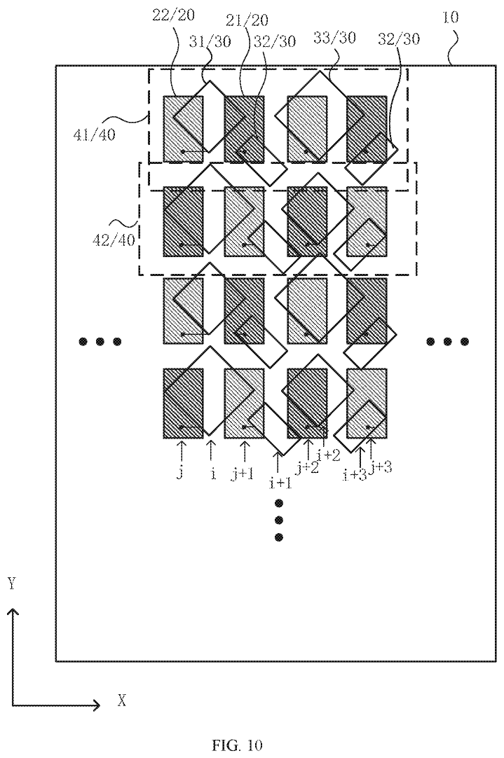

With reference to FIG. 10, which is a schematic plan view of a display panel illustrated in the related art, where for the specific circuit diagram of the pixel circuit, reference can be made to FIG. 2, and for the structural diagram of each film layer in the display panel, reference can be made to FIGS. 3 to 7. In the related art, since the first pixel circuits 21 and the second pixel circuits 22 are alternately arranged along the row direction X and the first pixel circuits 21 and the second pixel circuits 22 are alternately arranged along the column direction Y, one of the first color light-emitting element 31 in the first sub-unit 41 and the first color light-emitting element 31 in the second sub-unit 42 in a same repeating unit 40 is electrically connected to the first pixel circuit 21, and the other is electrically connected to the second pixel circuit 22. Channels of at least two transistors M in the first pixel circuit 21 and channels of at least two transistors M in the second pixel circuit 22 are mirror-symmetric with respect to the column direction Y. During the manufacturing process of the display panel, when the patterns between different film layers are not precisely aligned and misalignment occurs, it results in different changes in the potentials of at least some nodes in the first pixel circuit 21 and at least some nodes in the second pixel circuit 22. In some embodiments, when the pixel circuit 20 is a 7T1C circuit, taking the misalignment caused by the second metal layer MC and the semiconductor layer Poly not being precisely aligned as an example, when the second metal layer MC shifts to one side along the row direction X, it results in different overlap areas between the part of the first pixel circuit 21 located in the second metal layer MC and the part thereof located in the semiconductor layer Poly, and between the part of the second pixel circuit 22 located in the second metal layer MC and the part thereof located in the semiconductor layer Poly, thereby resulting in different parasitic capacitances between the two. Similarly, taking the misalignment caused by the first metal layer M1 and the semiconductor layer Poly not being precisely aligned as an example, when the first metal layer M1 shifts to one side along the row direction X, the coupling capacitance of the second scan signal line Scan2 to the sixth node N6 in the first pixel circuit 21 is different from the coupling capacitance thereof to the sixth node N6 in the second pixel circuit 22. The coupling capacitance of the emission control signal line Emit to the first node N1 and the third node N3 in the first pixel circuit 21 is different from the coupling capacitance thereof to the first node N1 and the third node N3 in the second pixel circuit 22. Due to the different changes in the potentials of at least some nodes in the first pixel circuit 21 and at least some nodes in the second pixel circuit 22, when a part of the first color light-emitting elements 31 are electrically connected to the first pixel circuits 21 and the other part of the first color light-emitting elements 31 are electrically connected to the second pixel circuits 22, there is a risk of different light-emitting effects between the two, thereby resulting in a risk of display non-uniformity.

With continued reference to FIGS. 1 to 9, in the display panel according to the present disclosure, the first color light-emitting elements 31 in the i-th column of light-emitting elements 30 are electrically connected to the first pixel circuits 21 in the (j+1)-th column of pixel circuits 20 respectively, and the first color light-emitting elements 31 in the (i+2)-th column of light-emitting elements 30 are electrically connected to the first pixel circuits 21 in the (j+2)-th column of pixel circuits 20 respectively, where 1≤i≤A, A is the total number of columns of the light-emitting elements 30, and 1≤j≤B, B is the total number of columns of the pixel circuits 20. That is, the first color light-emitting elements 31 in the i-th column of light-emitting elements 30 and the first color light-emitting elements 31 in the (i+2)-th column of light-emitting elements 30 are both electrically connected to the first pixel circuits 21. Thus, even if during the manufacturing process of the display panel, the patterns between different film layers are not precisely aligned, resulting in misalignment, which causes different changes in the potentials of at least some nodes in the first pixel circuit 21 and at least some nodes in the second pixel circuit 22, since the first color light-emitting elements 31 in the i-th column of light-emitting elements 30 and the first color light-emitting elements 31 in the (i+2)-th column of light-emitting elements 30 are both electrically connected to the first pixel circuits 21, changes in the potentials of the nodes in each of the first pixel circuits 21 are the same. Therefore, the influences of the changes in the potentials of the nodes in each of the first pixel circuits 21 on the first color light-emitting elements 31 in the i-th column of light-emitting elements 30 and on the first color light-emitting elements 31 in the (i+2)-th column of light-emitting elements 30 are the same, and thereby the light-emitting effects of the first color light-emitting elements 31 in the i-th column of light-emitting elements 30 and the first color light-emitting elements 31 in the (i+2)-th column of light-emitting elements 30 tend to be the same, which is conducive to improving the display effect.

In some optional embodiments, i=j.

Specifically, when the number of columns of the light-emitting elements 30 is the same as the number of columns of the pixel circuits 20, i=j. In this case, the first color light-emitting elements 31 in the i-th column of light-emitting elements 30 are electrically connected to the first pixel circuits 21 in an (i+1)-th column of pixel circuits 20 respectively, and the first color light-emitting elements 31 in the (i+2)-th column of light-emitting elements 30 are electrically connected to the first pixel circuits 21 in an (i+2)-th column of pixel circuits 20 respectively.

Optionally, dummy (Dummy) pixel circuits are usually provided in at least one of an upper bezel, a lower bezel, a left bezel, and a right bezel of the display panel, and in this case, the number of columns of the light-emitting elements 30 and the number of columns of the light-emitting elements 20 will be different. In this case, i≠j, and the corresponding relationship between i and j may be set according to actual conditions.

With continued reference to FIGS. 1 to 7, optionally, the display panel includes a plurality of data lines D1 extending along the column direction Y and arranged along the row direction X.

The pixel circuits 20 in different columns are electrically connected to different data lines D1 respectively; and
in the pixel circuits 20 in a same column, each of the first pixel circuits 21 is electrically connected to one of the data lines D1, each of the second pixel circuits 22 is electrically connected to another one of the data lines D1, and these two data lines D1 are located on two opposite sides of this column of pixel circuits 20 respectively.

Specifically, the pixel circuits 20 in the same column arranged along the column direction Y are electrically connected to two data lines D1 correspondingly, and each column of pixel circuits 20 realizes the writing of data signals through the two data lines D1 connected thereto, that is, a Double Data Line (DDL) driving mode is adopted. In this way, it is possible to reduce the jump influence caused by on-off switching of each of the pixel circuits connected to a same data line D1, improving the stability of the pixel circuits 20; and at the same time, it is possible to reduce the delay of the signals on the data line D1, improving the charging efficiency of the pixel circuits 20, and conducive to achieving high-frequency display.

These two data lines D1 electrically connected to the pixel circuits 20 in the same column arranged along the column direction Y are located on two opposite sides of this column of pixel circuits 20 respectively, and in this column of pixel circuits 20, each of the first pixel circuits 21 is electrically connected to one of the data lines D1, and each of the second pixel circuits 22 is electrically connected to another one of the data lines D1. Channels of at least two transistors M in the first pixel circuit 21 and channels of at least two transistors M in the second pixel circuit 22 are mirror-symmetric with respect to the column direction Y, so that the second node N2 in the first pixel circuit 21 is located on a side of the first pixel circuit 21 close to the data line D1 electrically connected thereto, and the second node N2 in the second pixel circuit 22 is located on a side of the second pixel circuit 22 close to the data line D1 electrically connected thereto. Therefore, there is no need to realize connection between the pixel circuits 20 and the data lines D1 through crosslines, thereby being conducive to reducing the coupling effect between the data lines D1 and other signal lines, and thus avoiding the crosstalk problem caused by the crosslines, and in turn improving the display performance of the display panel.

Optionally, the display panel further includes at least one gating circuit 50. In some embodiments, the gating circuit 50 includes a demultiplexer (demux). Two data lines D1 electrically connected to at least one column of pixel circuits 20 correspondingly are connected to a data signal terminal via the gating circuit 50. Herein, an input of the gating circuit 50 is electrically connected to the data signal terminal, and a plurality of outputs of the gating circuit 50 are electrically connected to the two data lines D1 electrically connected to at least one column of pixel circuits 20 correspondingly, respectively.

Each gating circuit 50 is electrically connected to at least one column of pixel circuits 20 correspondingly, that is, each gating circuit 50 may be electrically connected to one or more columns of the pixel circuits 20. The pixel circuits 20 connected to each gating circuit 50 correspondingly are mutually different, and each gating circuit 50 is connected to a different data signal terminal. In some embodiments, with reference to FIG. 1, each gating circuit 50 is electrically connected to two columns of the pixel circuits 20 correspondingly. That is, the data lines D1 electrically connected to the two columns of the pixel circuits 20 are connected to one data signal terminal via the gating circuit 50, namely, the ratio of the number of the data signal terminals connected to the gating circuit 50 to the number of the data lines D1 is 1:4. It should be noted that, in practical applications, the connection mode between each gating circuit 50 and the data lines D1 may be selected according to actual scenarios, and the ratio of the number of the data signal terminals connected to the gating circuit 50 to the number of the data lines D1 is 1:n, where n is an even number greater than or equal to 2, and the present disclosure does not make specific limitations thereto.

The data signal terminal is configured to provide a data signal Vdata. The gating circuit 50 is configured to transmit the data signal Vdata provided by the data signal terminal to the data lines D1 electrically connected to the gating circuit 50 in a time-division manner. That is, the gating circuit 50 is configured to turn on the paths between the data signal terminal and different data lines D1 in a time-division manner so as to transmit the data signal Vdata to the different data lines D1 in a time-division manner. In this way, a plurality of data lines D1 share a same data signal terminal through the gating circuit 50, which can reduce the number of the data signal terminals, conducive to achieving a display panel with a narrow bezel and high pixel density. Moreover, the delay of the signals on the data line D1 can be reduced, thereby improving the charging efficiency of the pixel circuits 20 and being conducive to achieving high-frequency display.

With continued reference to FIGS. 1 to 9, in some optional embodiments, the second pixel circuits 22 in a j-th column of pixel circuits 20 are electrically connected to part of the second color light-emitting elements 32 in an (i+1)-th column of light-emitting elements 30 respectively.

Specifically, the first color light-emitting elements 31 in the i-th column of light-emitting elements 30 are electrically connected to the first pixel circuits 21 in the (j+1)-th column of pixel circuits 20 respectively, and the first color light-emitting elements 31 in the (i+2)-th column of light-emitting elements 30 are electrically connected to the first pixel circuits 21 in the (j+2)-th column of pixel circuits 20 respectively, thereby achieving that the first color light-emitting elements 31 in the i-th column of light-emitting elements 30 and the first color light-emitting elements 31 in the (i+2)-th column of light-emitting elements 30 are both electrically connected to the first pixel circuits 21. Since the first color light-emitting elements 31 in the i-th column of light-emitting elements 30 are electrically connected to the first pixel circuits 21 in the (j+1)-th column of pixel circuits 20 respectively, part of the second color light-emitting elements 32 in the (i+1)-th column of light-emitting elements 30 cannot be electrically connected to the first pixel circuits 21 in the (j+1)-th column of pixel circuits 20 respectively. In this case, part of the second color light-emitting elements 32 in the (i+1)-th column of light-emitting elements 30 can be set to be electrically connected to the second pixel circuits 22 in the j-th column of pixel circuits 20 respectively. While achieving that the first color light-emitting elements 31 in the i-th column of light-emitting elements 30 are electrically connected to the first pixel circuits 21 in the (j+1)-th column of pixel circuits 20 respectively, part of the second color light-emitting elements 32 in the (i+1)-th column of light-emitting elements 30 which are electrically connected to the second pixel circuits 22 in the j-th column of pixel circuits 20 can be controlled by the second pixel circuits 22 in the j-th column of pixel circuits 20, achieving the light emission of part of the second color light-emitting elements 32 in the (i+1)-th column of light-emitting elements 30.

With continued reference to FIGS. 1 to 9, in some optional embodiments, the light-emitting element 30 includes a first electrode 301, a light-emitting layer (not shown in the drawings), and a second electrode (not shown in the drawings) that are stacked on one another, and the first electrode 301 is electrically connected to the first node N1 of the pixel circuit 20.

The first electrodes 301 of the first color light-emitting elements 31 in the i-th column of light-emitting elements 30 are electrically connected to the first nodes N1 of the first pixel circuits 21 in the (j+1)-th column of pixel circuits 20 through first connection portions 61.

Specifically, the light-emitting element 30 may be an organic light-emitting element, and the light-emitting element 30 includes a first electrode 301, a light-emitting layer, and a second electrode that are stacked on one another. The pixel circuit 20 includes a first node N1 electrically connected to a drain of the driving transistor. In some embodiments, with reference to FIG. 2, the pixel circuit 20 may be a 7T1C circuit, the third transistor M3 is the driving transistor, and the first node N1 is electrically connected to the drain of the third transistor M3. The first electrode 301 in the light-emitting element 30 is electrically connected to the first node N1 of the pixel circuit 20 corresponding thereto, so as to realize the control of the light-emitting element 30 electrically connected thereto to emit light through the pixel circuit 20.

There is a relatively large spacing between the first electrodes 301 of the first color light-emitting elements 31 in the i-th column of light-emitting elements 30 and the first nodes N1 of the first pixel circuits 21 in the (j+1)-th column of pixel circuits 20, and the first connection portions 61 can be provided to connect the first electrodes 301 of the first color light-emitting elements 31 in the i-th column of light-emitting elements 30 and the first nodes N1 of the first pixel circuits 21 in the (j+1)-th column of pixel circuits 20, realizing the corresponding electrical connection between the first color light-emitting elements 31 in the i-th column of light-emitting elements 30 and the first pixel circuits 21 in the (j+1)-th column of pixel circuits 20.

With continued reference to FIGS. 1 to 9, in some optional embodiments, the first nodes N1 of the second pixel circuits 22 in the j-th column of pixel circuits 20 are electrically connected to the first electrodes 301 of the second color light-emitting elements 32 in the (i+1)-th column of light-emitting elements 30 through second connection portions 62.

Specifically, since the first color light-emitting elements 31 in the i-th column of light-emitting elements 30 are electrically connected to the first pixel circuits 21 in the (j+1)-th column of pixel circuits 20 respectively, part of the second color light-emitting elements 32 in the (i+1)-th column of light-emitting elements 30 cannot be electrically connected to the first pixel circuits 21 in the (j+1)-th column of pixel circuits 20 respectively. In this case, part of the second color light-emitting elements 32 in the (i+1)-th column of light-emitting elements 30 can be set to be electrically connected to the second pixel circuits 22 in the j-th column of pixel circuits 20 respectively. While achieving that the first color light-emitting elements 31 in the i-th column of light-emitting elements 30 are electrically connected to the first pixel circuits 21 in the (j+1)-th column of pixel circuits 20 respectively, part of the second color light-emitting elements 32 in the (i+1)-th column of light-emitting elements 30 which are electrically connected to the second pixel circuits 22 in the j-th column of pixel circuits 20 can be controlled by the second pixel circuits 22 in the j-th column of pixel circuits 20, thereby achieving the light emission of part of the second color light-emitting elements 32 in the (i+1)-th column of light-emitting elements 30. Since there is a relatively large spacing between the first nodes N1 of the second pixel circuits 22 in the j-th column of pixel circuits 20 and the first electrodes 301 of the second color light-emitting elements 32 in the (i+1)-th column of light-emitting elements 30, the second connection portions 62 can be provided to electrically connect the first nodes N1 of the second pixel circuits 22 in the j-th column of pixel circuits 20 to the first electrodes 301 of the second color light-emitting elements 32 in the (i+1)-th column of light-emitting elements 30.

With continued reference to FIGS. 1 to 9, in some optional embodiments, the first connection portions 61 and the second connection portions 62 are located in a same film layer and are insulated from each other.

Specifically, the first connection portions 61 are configured to connect the first electrodes 301 of the first color light-emitting elements 31 in the i-th column of light-emitting elements 30 and the first nodes N1 of the first pixel circuits 21 in the (j+1)-th column of pixel circuits 20, the second connection portions 62 are configured to connect the first nodes N1 of the second pixel circuits 22 in the j-th column of pixel circuits 20 and the first electrodes 301 of the second color light-emitting elements 32 in the (i+1)-th column of light-emitting elements 30, and the first connection portions 61 and the second connection portions 62 are insulated from each other to avoid signal crosstalk and short circuit.

The first connection portions 61 and the second connection portions 62 are located in a same film layer, that is, the first connection portions 61 and the second connection portions 62 can be made of a same material in a same process, which is conducive to reducing the manufacturing process and production cost.

With continued reference to FIGS. 3 to 9, in some optional embodiments, the display panel further includes a plurality of reference voltage signal lines Vref extending along the row direction X.

The first connection portions 61 and the reference voltage signal lines Vref are located in a same film layer.

Specifically, the display panel includes a second metal layer MC. The second metal layer MC includes the reference voltage signal lines Vref. The first connection portions 61 and the reference voltage signal lines Vref are located in a same film layer, that is, the second metal layer MC further includes the first connection portions 61, namely, the first connection portions 61 and the reference voltage signal lines Vref can be made of a same material in a same process, which is conducive to reducing the manufacturing process and production cost.

Optionally, the reference voltage signal lines Vref include first reference voltage signal lines Vref1, and second reference voltage signal lines Vref2. The first reference voltage signal lines Vref1, the first power supply signal lines PVDD extending along the row direction X, and the second reference voltage signal lines Vref2 are arranged alternately in sequence along the column direction Y. A vertical projection of the first node N1 onto the substrate 10 is located between a vertical projection of the first power supply signal line PVDD extending along the row direction X onto the substrate 10 and a vertical projection of the second reference voltage signal line Vref2 onto the substrate 10, and an interval between the first power supply signal line PVDD extending along the row direction X and the second reference voltage signal line Vref2 is relatively large. Therefore, a first connection portion 61 of the first connection portions 61 can be provided between one of the first power supply signal lines PVDD extending along the row direction X and one of the second reference voltage signal lines Vref2, thereby facilitating the connection of the first electrodes 301 of the first color light-emitting elements 31 in the i-th column of light-emitting elements 30 and the first nodes N1 of the first pixel circuits 21 in the (j+1)-th column of pixel circuits 20 through the first connection portions 61. Moreover, the provision of the first connection portions 61 does not affect the provision of other wires in the display panel.

Similarly, optionally, the display panel further includes a plurality of reference voltage signal lines Vref extending along the row direction X.

The second connection portions 62 and the reference voltage signal lines Vref are located in a same film layer.

Specifically, the display panel includes a second metal layer MC. The second metal layer MC includes the reference voltage signal lines Vref. The second connection portions 62 and the reference voltage signal lines Vref are located in a same film layer, that is, the second metal layer MC further includes the second connection portions 62, namely, the second connection portions 62 and the reference voltage signal lines Vref can be made of a same material in a same process, which is conducive to reducing the manufacturing process and production cost.

Optionally, the reference voltage signal lines Vref include first reference voltage signal line Vref1, and second reference voltage signal lines Vref2. The first reference voltage signal lines Vref1, the first power supply signal lines PVDD extending along the row direction X, and the second reference voltage signal lines Vref2 are arranged alternately in sequence along the column direction Y. A vertical projection of the first node N1 onto the substrate 10 is located between a vertical projection of the first power supply signal line PVDD extending along the row direction X onto the substrate 10 and a vertical projection of the second reference voltage signal line Vref2 onto the substrate 10, and an interval between the first power supply signal line PVDD extending along the row direction X and the second reference voltage signal line Vref2 is relatively large. Therefore, a second connection portion 62 of the second connection portions 62 can be provided between one of the first power supply signal lines PVDD extending along the row direction X and one of the second reference voltage signal lines Vref2, thereby facilitating the connection of the first electrodes 301 of the second color light-emitting elements 32 in the (i+1)-th column of light-emitting elements 30 and the first nodes N1 of the second pixel circuits 22 in the j-th column of pixel circuits 20 through the second connection portions 62. Moreover, the provision of the second connection portions 62 does not affect the provision of other wires in the display panel.

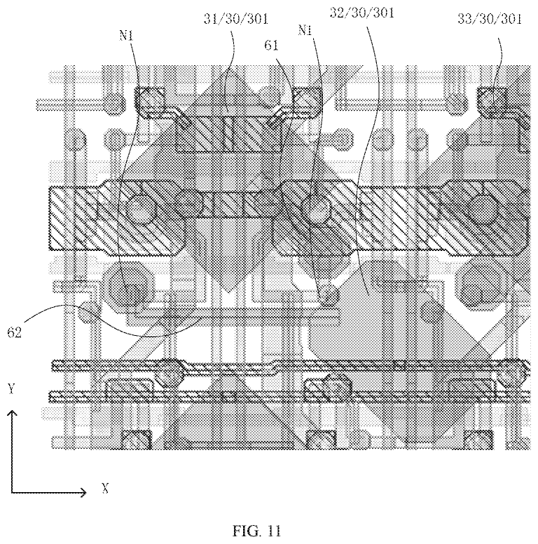

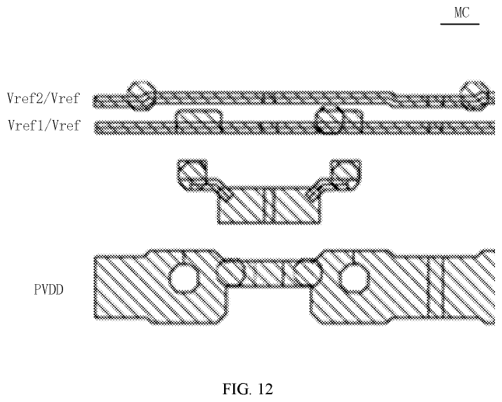

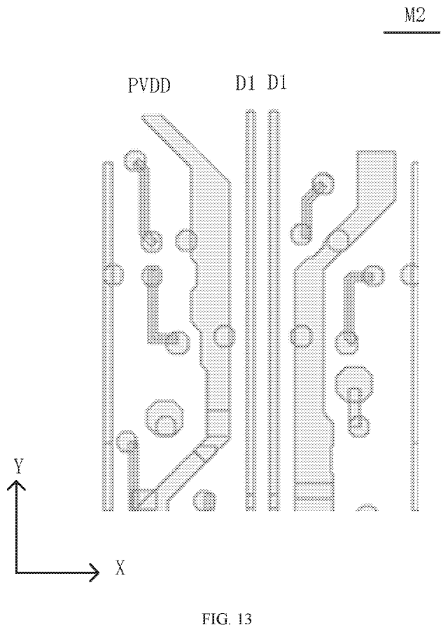

FIG. 11 is a schematic diagram of another layout structure of the display panel shown in FIG. 1. FIG. 12 is a schematic diagram of a layout structure of another second metal layer according to the present disclosure. FIG. 13 is a schematic diagram of a layout structure of another third metal layer according to the present disclosure. With reference to FIGS. 4, 5, 8, and 11 to 13, in some optional embodiments, the first connection portions 61 and the first electrodes 301 are located in a same film layer, that is, the first connection portions 61 and the first electrodes 301 can be made of a same material in a same process, which is conducive to reducing the manufacturing process and production cost.

Similarly, optionally, the second connection portions 62 and the first electrodes 301 are located in a same film layer, that is, the second connection portions 62 and the first electrodes 301 can be made of a same material in a same process, which is conducive to reducing the manufacturing process and production cost.

It can be understood that in the embodiments of the present disclosure, it is exemplarily shown that the first connection portions 61 and the second connection portions 62 can be provided in the same layer as the reference voltage signal lines Vref or the first electrodes 301. In other embodiments of the present disclosure, the first connection portions 61 and the second connection portions 62 may also be provided in another film layer according to actual requirements, which will not be described in the present disclosure.

It should be noted that embodiments of the present disclosure only exemplarily show the film layer arrangement manner of the first connection portions 61 and the second connection portions 62. In other embodiments of the present disclosure, when the display panel includes other connection portions connecting the first nodes N1 of the pixel circuits 20 and the first electrodes 301 of the light-emitting elements 30, reference may be made to the film layer arrangement manner of the first connection portions 61 and the second connection portions 62, which will not be described in the present disclosure.

With continued reference to FIGS. 1 to 9, in some optional embodiments, the pixel circuit 20 includes a driving transistor;
in a same pixel circuit 20, the first node N1 is located on a side of the driving transistor along the column direction Y; and
along a direction perpendicular to a plane of the substrate 10, a first connection portion 61 of the first connection portions 61 and/or a second connection portion 62 of the second connection portions 62 are/is located between two rows of driving transistors which are adjacent to each other in the column direction Y.

Specifically, in the same pixel circuit 20, the first node N1 is located on a side of the driving transistor along the column direction Y, and along the direction perpendicular to the plane of the substrate 10, the first connection portion 61 may be located between two rows of driving transistors which are adjacent to each other in the column direction Y, thereby facilitating the connection of the first electrodes 301 of the first color light-emitting elements 31 in the i-th column of light-emitting elements 30 and the first nodes N1 of the first pixel circuits 21 in the (j+1)-th column of pixel circuits 20 through the first connection portions 61, and the provision of the first connection portions 61 does not affect the provision of other wires in the display panel. Similarly, along the direction perpendicular to the plane of the substrate 10, the second connection portion 62 may be located between two rows of driving transistors which are adjacent to each other in the column direction Y, thereby facilitating the connection of the first electrodes 301 of the second color light-emitting elements 32 in the (i+1)-th column of light-emitting elements 30 and the first nodes N1 of the second pixel circuits 22 in the j-th column of pixel circuits 20 through the second connection portions 62, and the provision of the second connection portions 62 does not affect the provision of other wires in the display panel.

In some embodiments, the pixel circuit 20 may be a 7T1C circuit. The third transistor M3 is a driving transistor. The first node N1 is electrically connected to a drain of the third transistor M3. Along the column direction Y, the first node N1 is located on a side of the third transistor M3 electrically connected thereto. Along the direction perpendicular to the plane of the substrate 10, a first connection portion of the first connection portions 61 and a second connection portion of the second connection portions 62 may be located between two adjacent rows of third transistors M3 in the column direction Y, thereby facilitating the provision of the first connection portions 61 and the second connection portions 62.

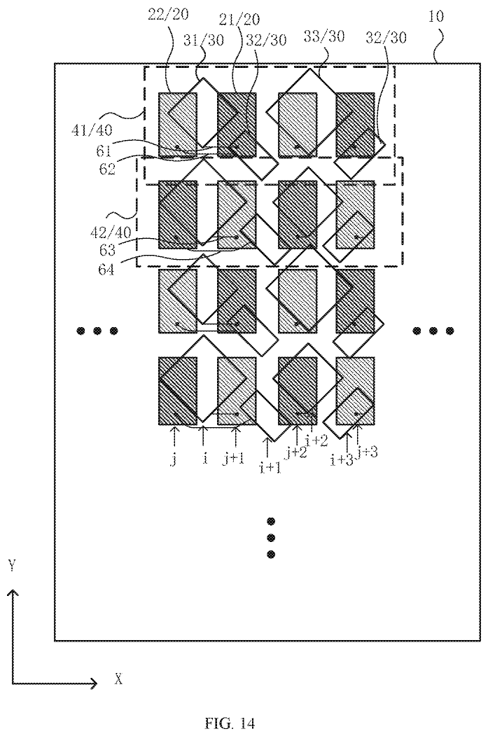

FIG. 14 is still another schematic plan view of the display panel shown in FIG. 1. With reference to FIGS. 1 to 7 and 14, in some optional embodiments, the third color light-emitting elements 33 in the i-th column of light-emitting elements 30 are electrically connected to the second pixel circuits 22 in the (j+1)-th column of pixel circuits 20 respectively; and
the third color light-emitting elements 33 in the (i+2)-th column of light-emitting elements 30 are electrically connected to the second pixel circuits 22 in the (j+2)-th column of pixel circuits 20 respectively.

With continued reference to FIG. 10, for the specific circuit diagram of the pixel circuit, reference can be made to FIG. 2, and for the structural diagram of each film layer in the display panel, reference can be made to FIGS. 3 to 7. In the related art, since the first pixel circuits 21 and the second pixel circuits 22 are arranged alternately along the row direction X and the first pixel circuits 21 and the second pixel circuits 22 are arranged alternately along the column direction Y, one of the third color light-emitting element 33 in the first sub-unit 41 and the third color light-emitting element 33 in the second sub-unit 42 in a same repeating unit 40 is electrically connected to the first pixel circuit 21, and the other is electrically connected to the second pixel circuit 22. Channels of at least two transistors in the first pixel circuit 21 and channels of at least two transistors in the second pixel circuit 22 are mirror-symmetric with respect to the column direction. During the manufacturing process of the display panel, when the patterns between different film layers are not precisely aligned and misalignment occurs, it results in different changes in the potentials of at least some nodes in the first pixel circuit 21 and at least some nodes in the second pixel circuit 22. In some embodiments, when the pixel circuit 20 is a 7T1C circuit, taking the misalignment caused by the second metal layer MC and the semiconductor layer Poly not being precisely aligned as an example, when the second metal layer MC shifts to one side along the row direction X, it results in different overlap areas between the part of the first pixel circuit 21 located in the second metal layer MC and the part thereof located in the semiconductor layer Poly, and between the part of the second pixel circuit 22 located in the second metal layer MC and the part thereof located in the semiconductor layer Poly, thereby resulting in different parasitic capacitances between the two. Similarly, taking the misalignment caused by the first metal layer M1 and the semiconductor layer Poly not being precisely aligned as an example, when the first metal layer M1 shifts to one side along the row direction X, the coupling capacitance of the second scan signal line Scan2 to the sixth node N6 in the first pixel circuit 21 is different from the coupling capacitance thereof to the sixth node N6 in the second pixel circuit 22. The coupling capacitance of the emission control signal line Emit to the first node N1 and the third node N3 in the first pixel circuit 21 is different from the coupling capacitance thereof to the first node N1 and the third node N3 in the second pixel circuit 22. Due to the different changes in the potentials of at least some nodes in the first pixel circuit 21 and at least some nodes in the second pixel circuit 22, when a part of the third color light-emitting elements 33 are electrically connected to the first pixel circuits 21 and the other part of the third color light-emitting elements 33 are electrically connected to the second pixel circuits 22, there is a risk of different light-emitting effects between the two, thereby resulting in a risk of display non-uniformity.

Specifically, in the display panel according to the present disclosure, the third color light-emitting elements 33 in the i-th column of light-emitting elements 30 are electrically connected to the second pixel circuits 22 in the (j+1)-th column of pixel circuits 20 respectively, and the third color light-emitting elements 33 in the (i+2)-th column of light-emitting elements 30 are electrically connected to the second pixel circuits 22 in the (j+2)-th column of pixel circuits 20 respectively. That is, the third color light-emitting elements 33 in the i-th column of light-emitting elements 30 and the third color light-emitting elements 33 in the (i+2)-th column of light-emitting elements 30 are both electrically connected to the second pixel circuits 22. Thus, even if during the manufacturing process of the display panel, the patterns between different film layers are not precisely aligned, resulting in misalignment, which causes different changes in the potentials of at least some nodes in the first pixel circuit 21 and at least some nodes in the second pixel circuit 22, since the third color light-emitting elements 33 in the i-th column of light-emitting elements 30 and the third color light-emitting elements 33 in the (i+2)-th column of light-emitting elements 30 are both electrically connected to the second pixel circuits 22, changes in the potentials of the nodes in each of the second pixel circuits 22 are the same. Therefore, the influences of the changes in the potentials of the nodes in each of the second pixel circuits 22 on the third color light-emitting elements 33 in the i-th column of light-emitting elements 30 and on the third color light-emitting elements 33 in the (i+2)-th column of light-emitting elements 30 are the same, and thereby the light-emitting effects of the third color light-emitting elements 33 in the i-th column of light-emitting elements 30 and the third color light-emitting elements 33 in the (i+2)-th column of light-emitting elements 30 tend to be the same, which is conducive to improving the display effect.

Optionally, the first electrodes of the third color light-emitting elements 33 in the i-th column of light-emitting elements 30 are electrically connected to the first nodes N1 of the second pixel circuits 22 in the (j+1)-th column of pixel circuits 20 through third connection portions 63, thereby achieving that the third color light-emitting elements 33 in the i-th column of light-emitting elements 30 are electrically connected to the second pixel circuits 22 in the (j+1)-th column of pixel circuits 20 respectively.

It should be noted that the structures of the third connection portions 63 can be set with reference to the structures of the first connection portions 61, and will not be described in the present disclosure.

With continued reference to FIGS. 1 to 7 and 14, in some optional embodiments, the first pixel circuits 21 in the j-th column of pixel circuits 20 are electrically connected to part of the second color light-emitting elements 32 in the (i+1)-th column of light-emitting elements 30 respectively.

Specifically, the third color light-emitting elements 33 in the i-th column of light-emitting elements 30 are electrically connected to the second pixel circuits 22 in the (j+1)-th column of pixel circuits 20 respectively, and the third color light-emitting elements 33 in the (i+2)-th column of light-emitting elements 30 are electrically connected to the second pixel circuits 22 in the (j+2)-th column of pixel circuits 20 respectively, thereby achieving that the third color light-emitting elements 33 in the i-th column of light-emitting elements 30 and the third color light-emitting elements 33 in the (i+2)-th column of light-emitting elements 30 are both electrically connected to the second pixel circuits 22. Since the third color light-emitting elements 33 in the i-th column of light-emitting elements 30 are electrically connected to the second pixel circuits 22 in the (j+1)-th column of pixel circuits 20 respectively, part of the second color light-emitting elements 32 in the (i+1)-th column of light-emitting elements 30 cannot be electrically connected to the second pixel circuits 22 in the (j+1)-th column of pixel circuits 20 respectively. In this case, part of the second color light-emitting elements 32 in the (i+1)-th column of light-emitting elements 30 can be set to be electrically connected to the first pixel circuits 21 in the j-th column of pixel circuits 20 respectively. While achieving that the third color light-emitting elements 33 in the i-th column of light-emitting elements 30 are electrically connected to the second pixel circuits 22 in the (j+1)-th column of pixel circuits 20 respectively, part of the second color light-emitting elements 32 in the (i+1)-th column of light-emitting elements 30 which are electrically connected to the first pixel circuits 21 in the j-th column of pixel circuits 20 can be controlled by the first pixel circuits 21 in the j-th column of pixel circuits 20, thereby achieving the light emission of part of the second color light-emitting elements 32 in the (i+1)-th column of light-emitting elements 30.

Moreover, with such arrangement, among the light-emitting elements 30 arranged along the row direction X, the second color light-emitting elements 32 electrically connected to the first pixel circuits 21 and the second color light-emitting elements 32 electrically connected to the second pixel circuits 22 are arranged alternately; and among the light-emitting elements 30 arranged along the column direction Y, the second color light-emitting elements 32 electrically connected to the first pixel circuits 21 and the second color light-emitting elements 32 electrically connected to the second pixel circuits 22 are arranged alternately. Thus, even if during the manufacturing process of the display panel, the patterns between different film layers are not precisely aligned, resulting in misalignment that exerts different influences on the second color light-emitting elements 32 electrically connected to the first pixel circuits 21 and the second color light-emitting elements 32 electrically connected to the second pixel circuits 22, the second color light-emitting elements 32 electrically connected to the first pixel circuits 21 can be prevented from being locally intensively provided, and the second color light-emitting elements 32 electrically connected to the second pixel circuits 22 can also be prevented from being locally intensively provided, so that the light of the second color can be prevented from being too bright or too dark locally to form bright spots or dark spots visible to the naked eyes, which is conducive to improving the display effect.

In some embodiments, during the manufacturing process of the display panel, when the patterns between different film layers are not precisely aligned, resulting in misalignment, such that the brightness of the second color light emitted by the second color light-emitting elements 32 electrically connected to the first pixel circuits 21 is higher than the brightness of the second color light emitted by the second color light-emitting elements 32 electrically connected to the second pixel circuits 22, among the light-emitting elements 30 arranged along the row direction X, the second color light-emitting elements 32 electrically connected to the first pixel circuits 21 and the second color light-emitting elements 32 electrically connected to the second pixel circuits 22 are arranged alternately, and among the light-emitting elements 30 arranged along the column direction Y, the second color light-emitting elements 32 electrically connected to the first pixel circuits 21 and the second color light-emitting elements 32 electrically connected to the second pixel circuits 22 are arranged alternately, which can prevent the second color light-emitting elements 32 electrically connected to the first pixel circuits 21 from being locally intensively provided, and can also prevent the second color light-emitting elements 32 electrically connected to the second pixel circuits 22 from being locally intensively provided, thereby preventing the formation of bright spots or dark spots visible to the naked eyes.

Optionally, the first electrodes of part of the second color light-emitting elements 32 in the (i+1)-th column of light-emitting elements 30 are electrically connected to the first nodes N1 of the first pixel circuits 21 in the j-th column of pixel circuits 20 through fourth connection portions 64, thereby achieving the corresponding electrical connection between part of the second color light-emitting elements 32 in the (i+1)-th column of light-emitting elements 30 and the first pixel circuits 21 in the j-th column of pixel circuits 20.

It should be noted that the structures of the fourth connection portions 64 can be set with reference to the structures of the second connection portions 62, and will not be described in the present disclosure.

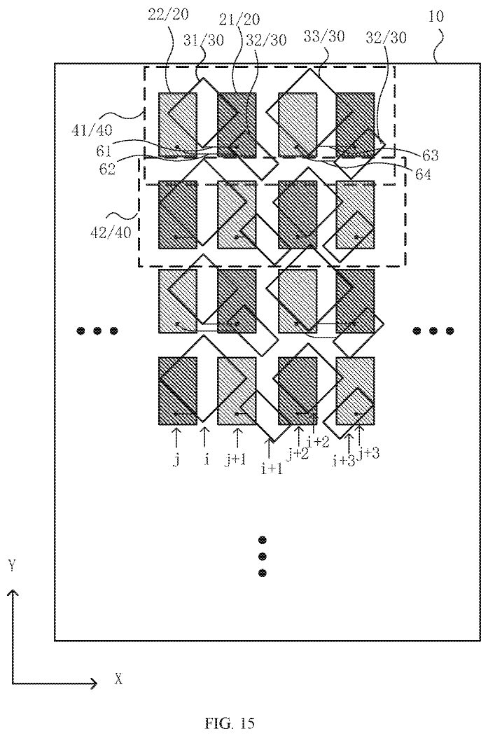

FIG. 15 is still another schematic plan view of the display panel shown in FIG. 1. With continued reference to FIGS. 1 to 7 and 15, in some optional embodiments, the third color light-emitting elements 33 in the (i+2)-th column of light-emitting elements 30 are electrically connected to the first pixel circuits 21 in a (j+3)-th column of pixel circuits 20 respectively; and
the third color light-emitting elements 33 in the i-th column of light-emitting elements 30 are electrically connected to the first pixel circuits 21 in the j-th column of pixel circuits 20 respectively.

With continued reference to FIG. 10, where for the specific circuit diagram of the pixel circuit, reference can be made to FIG. 2, and for the structural diagram of each film layer in the display panel, reference can be made to FIGS. 3 to 7. In the related art, since the first pixel circuits 21 and the second pixel circuits 22 are arranged alternately along the row direction X, and the first pixel circuits 21 and the second pixel circuits 22 are alternately arranged along the column direction Y, one of the third color light-emitting element 33 in the first sub-unit 41 and the third color light-emitting element 33 in the second sub-unit 42 in a same repeating unit 40 is electrically connected to the first pixel circuit 21, and the other is electrically connected to the second pixel circuit 22. Channels of at least two transistors in the first pixel circuit 21 and channels of at least two transistors in the second pixel circuit 22 are mirror-symmetrical with respect to the column direction. During the manufacturing process of the display panel, when the patterns between different film layers are not precisely aligned and misalignment occurs, it results in different changes in the potentials of at least some nodes in the first pixel circuit 21 and at least some nodes in the second pixel circuit 22. In some embodiments, when the pixel circuit 20 is a 7T1C circuit, taking the misalignment caused by the second metal layer MC and the semiconductor layer Poly not being precisely aligned as an example, when the second metal layer MC shifts to one side along the row direction X, it results in different overlapping areas between the part of the first pixel circuit 21 located in the second metal layer MC and the part thereof located in the semiconductor layer Poly, and between the part of the second pixel circuit 22 located in the second metal layer MC and the part thereof located in the semiconductor layer Poly, thereby leading to different parasitic capacitances for the two. Similarly, taking the misalignment caused by the first metal layer M1 and the semiconductor layer Poly not being precisely aligned as an example, when the first metal layer M1 shifts to one side along the row direction X, the coupling capacitance of the second scan signal line Scan2 to the sixth node N6 in the first pixel circuit 21 is different from the coupling capacitance thereof to the sixth node N6 in the second pixel circuit 22. The coupling capacitance of the light emission control signal line Emit to the first node N1 and the third node N3 in the first pixel circuit 21 is different from the coupling capacitance thereof to the first node N1 and the third node N3 in the second pixel circuit 22. Due to the different changes in the potentials of at least some nodes in the first pixel circuit 21 and at least some nodes in the second pixel circuit 22, when a part of the third color light-emitting elements 33 are electrically connected to the first pixel circuits 21 and the other part of the third color light-emitting elements 33 are electrically connected to the second pixel circuits 22, there is a risk of different light-emitting effects between the two, thereby resulting in a risk of display non-uniformity.

Specifically, in the display panel according to the present disclosure, the third color light-emitting elements 33 in the (i+2)-th column of light-emitting elements 30 are electrically connected to the first pixel circuits 21 in the (j+3)-th column of pixel circuits 20 respectively, and the third color light-emitting elements 33 in the i-th column of light-emitting elements 30 are electrically connected to the first pixel circuits 21 in the j-th column of pixel circuits 20 respectively. That is, the third color light-emitting elements 33 in the i-th column of light-emitting elements 30 and the third color light-emitting elements 33 in the (i+2)-th column of light-emitting elements 30 are both electrically connected to the first pixel circuits 21. Thus, even if during the manufacturing process of the display panel, the patterns between different film layers are not precisely aligned, resulting in misalignment that causes different changes in the potentials of at least some nodes in the first pixel circuit 21 and at least some nodes in the second pixel circuit 22, since the third color light-emitting elements 33 in the i-th column of light-emitting elements 30 and the third color light-emitting elements 33 in the (i+2)-th column of light-emitting elements 30 are both electrically connected to the second pixel circuits 22, changes in the potentials of the nodes in each of the second pixel circuits 22 are the same. Therefore, the influences of the changes in the potentials of the nodes in each of the second pixel circuits 22 on the third color light-emitting elements 33 in the i-th column of light-emitting elements 30 and on the third color light-emitting elements 33 in the (i+2)-th column of light-emitting elements 30 are the same, and thereby the light-emitting effects of the third color light-emitting elements 33 in the i-th column of light-emitting elements 30 and the third color light-emitting elements 33 in the (i+2)-th column of light-emitting elements 30 tend to be the same, which is conducive to improving the display effect.

Optionally, the first electrodes of the third color light-emitting elements 33 in the (i+2)-th column of light-emitting elements 30 are electrically connected to the first nodes N1 of the first pixel circuits 21 in the (j+3)-th column of pixel circuits 20 through third connection portions 63, thereby achieving the corresponding electrical connection between the third color light-emitting elements 33 in the (i+2)-th column of light-emitting elements 30 and the first pixel circuits 21 in the (j+3)-th column of pixel circuits 20.

It should be noted that the structures of the third connection portions 63 can be set with reference to the structures of the first connection portions 61, and will not be described in detail in the present disclosure.

With continued reference to FIGS. 1 to 7 and 15, in some optional embodiments, the second pixel circuits 22 in the (j+2)-th column of pixel circuits 20 are electrically connected to part of the second color light-emitting elements 32 in an (i+3)-th column of light-emitting elements 30 respectively.

Specifically, the third color light-emitting elements 33 in the (i+2)-th column of light-emitting elements 30 are electrically connected to the first pixel circuits 21 in the (j+3)-th column of pixel circuits 20 respectively, and the third color light-emitting elements 33 in the i-th column of light-emitting elements 30 are electrically connected to the first pixel circuits 21 in the j-th column of pixel circuits 20 respectively, thereby achieving that the third color light-emitting elements 33 in the i-th column of light-emitting elements 30 and the third color light-emitting elements 33 in the (i+2)-th column of light-emitting elements 30 are both electrically connected to the first pixel circuits 21. Since the third color light-emitting elements 33 in the (i+2)-th column of light-emitting elements 30 are electrically connected to the first pixel circuits 21 in the (j+3)-th column of pixel circuits 20 respectively, part of the second color light-emitting elements 32 in the (i+3)-th column of light-emitting elements 30 cannot be electrically connected to the first pixel circuits 21 in the (j+3)-th column of pixel circuits 20 respectively. In this case, part of the second color light-emitting elements 32 in the (i+3)-th column of light-emitting elements 30 can be set to be electrically connected to the second pixel circuits 22 in the (j+2)-th column of pixel circuits 20 respectively. While achieving that the third color light-emitting elements 33 in the (i+2)-th column of light-emitting elements 30 are electrically connected to the first pixel circuits 21 in the (j+3)-th column of pixel circuits 20 respectively, part of the second color light-emitting elements 32 in the (i+3)-th column of light-emitting elements 30 which are electrically connected to the second pixel circuits 22 in the (j+2)-th column of pixel circuits 20 can be controlled by the second pixel circuits 22 in the (j+2)-th column of pixel circuits 20, achieving the light emission of part of the second color light-emitting elements 32 in the (i+3)-th column of light-emitting elements 30.

Moreover, with such arrangement, all the second color light-emitting elements 32 are electrically connected to the second pixel circuits 22. Thus, even if during the manufacturing process of the display panel, the patterns between different film layers are not precisely aligned, resulting in misalignment that causes different changes in the potentials of at least some nodes in the first pixel circuit 21 and at least some nodes in the second pixel circuit 22, since all the second color light-emitting elements 32 are electrically connected to the second pixel circuits 22, changes in the potentials of the nodes in each of the second pixel circuits 22 are the same. Therefore, the influences of the changes in the potentials of the nodes in each of the second pixel circuits 22 on all the second color light-emitting elements 32 are the same, so that the light-emitting effects of all the second color light-emitting elements 32 tend to be the same, which is conducive to improving the display effect.

Optionally, the first electrodes of part of the second color light-emitting elements 32 in the (i+3)-th column of light-emitting elements 30 are electrically connected to the first nodes N1 of the second pixel circuits 22 in the (j+2)-th column of pixel circuits 20 through fourth connection portions 64, thereby achieving the corresponding electrical connection between part of the second color light-emitting elements 32 in the (i+3)-th column of light-emitting elements 30 and the second pixel circuits 22 in the (j+2)-th column of pixel circuits 20.

It should be noted that the structures of the fourth connection portions 64 can be set with reference to the structures of the second connection portions 62, and will not be described in detail in the present disclosure.

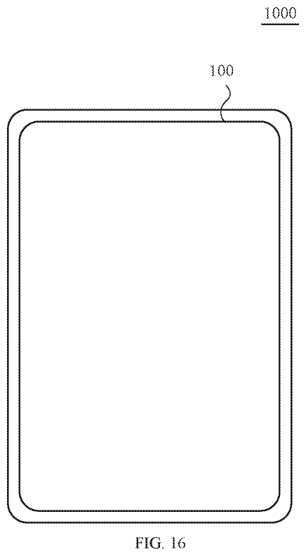

As shown in FIG. 16, which is a schematic plan view of a display apparatus according to the present disclosure, an embodiment of the present disclosure further provides a display apparatus 1000, including the display panel 100 according to any of the above embodiments. The embodiment provided in FIG. 16 merely takes a mobile phone as an example to illustrate the display apparatus. It can be understood that the display apparatus according to the embodiment of the present disclosure may be any electronic product having a display function, including but not limited to the following categories: a mobile phone, a television, a notebook computer, a desktop display, a tablet computer, a digital camera, a smart bracelet, smart glasses, a vehicle-mounted display, medical equipment, industrial control equipment, a touch interaction terminal, etc., which are not specially limited in the embodiments of the present disclosure.

The display apparatus according to the embodiment of the present disclosure has the same technical features as the display panel according to the above embodiments, thus it can also solve the same technical problems and achieve the same technical effects.

It should be noted that in this document, relational terms such as “first” and “second” are only used to distinguish one entity or operation from another entity or operation, and do not necessarily require or imply that there is any such actual relationship or order between these entities or operations. Moreover, the terms “comprise”, “include” or any other variants thereof are intended to cover non-exclusive inclusion, so that a process, method, article or device including a series of elements not only includes those elements, but also includes other elements not explicitly listed, or also includes inherent elements of such process, method, article or device. Without further limitation, the element defined by the phrase “including a . . .” does not exclude the presence of additional identical elements in the process, method, article or device including the element.

The above are only specific implementations of the present disclosure, enabling those skilled in the art to understand or implement the present disclosure. Various modifications to these embodiments will be apparent to those skilled in the art, and the general principles defined herein can be implemented in other embodiments without departing from the spirit or scope of the present disclosure. Therefore, the present disclosure will not be limited to the embodiments described herein, but should conform to the widest scope consistent with the principles and novel features disclosed herein.

What is claimed is:

1. A display panel, comprising:
a substrate;
a plurality of pixel circuits arranged in an array, wherein a pixel circuit of the plurality of pixel circuits comprises a plurality of transistors, a transistor of the plurality of transistors comprises a channel, the pixel circuits comprise first pixel circuits and second pixel circuits, the first pixel circuits and the second pixel circuits are alternately arranged along a row direction, the first pixel circuits and the second pixel circuits are alternately arranged along a column direction, and channels of at least two transistors in a first pixel circuit of the first pixel circuits and channels of at least two transistors in a second pixel circuit of the second pixel circuits are mirror-symmetric with respect to the column direction, wherein the row direction intersects with the column direction;
a plurality of light-emitting elements, wherein the plurality of light-emitting elements comprise first color light-emitting elements, second color light-emitting elements, and third color light-emitting elements with different emission colors;
a plurality of repeating units arranged in an array, wherein a repeating unit of the plurality of repeating units comprises a first sub-unit and a second sub-unit arranged along the column direction, the first sub-unit comprises a first color light-emitting element, a second color light-emitting element, a third color light-emitting element, and a second color light-emitting element that are arranged in sequence along the row direction, and the second sub-unit comprises a third color light-emitting element, a second color light-emitting element, a first color light-emitting element, and a second color light-emitting element that are arranged in sequence along the row direction,
wherein the first color light-emitting elements in an i-th column of light-emitting elements are electrically connected to the first pixel circuits in a (j+1)-th column of pixel circuits respectively; and
the first color light-emitting elements in an (i+2)-th column of light-emitting elements are electrically connected to the first pixel circuits in a (j+2)-th column of pixel circuits respectively.

2. The display panel according to claim 1, wherein
the second pixel circuits in a j-th column of pixel circuits are electrically connected to part of the second color light-emitting elements in an (i+1)-th column of light-emitting elements respectively.

3. The display panel according to claim 2, wherein
a light-emitting element of the plurality of light-emitting elements comprises a first electrode, a light-emitting layer, and a second electrode that are stacked on one another, and the first electrode is electrically connected to a first node of the pixel circuit; and
the first electrodes of the first color light-emitting elements in the i-th column of light-emitting elements are electrically connected to the first nodes of the first pixel circuits in the (j+1)-th column of pixel circuits through first connection portions.

4. The display panel according to claim 3, wherein
the first nodes of the second pixel circuits in the j-th column of pixel circuits are electrically connected to the first electrodes of the second color light-emitting elements in the (i+1)-th column of light-emitting elements through second connection portions.

5. The display panel according to claim 4, wherein
the first connection portions and the second connection portions are located in a same film layer and insulated from each other.

6. The display panel according to claim 5, further comprising:
a plurality of reference voltage signal lines extending along the row direction, wherein the first connection portions and the reference voltage signal lines are located in a same film layer.

7. The display panel according to claim 5, wherein the first connection portions and the first electrode are located in a same film layer.

8. The display panel according to claim 5, wherein
the pixel circuit comprises a driving transistor;
in a same pixel circuit, the first node is located on a side of the driving transistor along the column direction; and
along a direction perpendicular to a plane of the substrate, a first connection portion of the first connection portions and/or a second connection portion of the second connection portions are/is located between two rows of the driving transistors which are adjacent to each other in the column direction.

9. The display panel according to claim 1, wherein
the third color light-emitting elements in the i-th column of light-emitting elements are electrically connected to the second pixel circuits in the (j+1)-th column of pixel circuits respectively; and
the third color light-emitting elements in the (i+2)-th column of light-emitting elements are electrically connected to the second pixel circuits in the (j+2)-th column of pixel circuits respectively.

10. The display panel according to claim 9, wherein
the first pixel circuits in a j-th column of pixel circuits are electrically connected to part of the second color light-emitting elements in an (i+1)-th column of light-emitting elements respectively.

11. The display panel according to claim 1, wherein
the third color light-emitting elements in the (i+2)-th column of light-emitting elements are electrically connected to the first pixel circuits in a (j+3)-th column of pixel circuits respectively; and
the third color light-emitting elements in the i-th column of light-emitting elements are electrically connected to the first pixel circuits in a j-th column of pixel circuits respectively.

12. The display panel according to claim 11, wherein
the second pixel circuits in the (j+2)-th column of pixel circuits are electrically connected to part of the second color light-emitting elements in an (i+3)-th column of light-emitting elements respectively.

13. The display panel according to claim 1, wherein
the first color light-emitting elements are red light-emitting elements, the second color light-emitting elements are green light-emitting elements, and the third color light-emitting elements are blue light-emitting elements.

14. The display panel according to claim 1, wherein
the display panel further comprises a plurality of data lines extending along the column direction and arranged along the row direction;
the pixel circuits in different columns are electrically connected to different data lines respectively; and
in the pixel circuits in a same column, each of the first pixel circuits is electrically connected to one of the data lines, each of the second pixel circuits is electrically connected to another one of the data lines, and these two data lines are located on two opposite sides of this column of pixel circuits respectively.

15. The display panel according to claim 1, wherein i=j.

16. The display panel according to claim 1, wherein
in the first sub-unit, any two adjacent light-emitting elements at least partially overlap along the row direction; and
in the second sub-unit, any two adjacent light-emitting elements at least partially overlap along the row direction.

17. A display apparatus, comprising a display panel, wherein display panel comprises:
a substrate;
a plurality of pixel circuits arranged in an array, wherein a pixel circuit of the plurality of pixel circuits comprises a plurality of transistors, a transistor of the plurality of transistors comprises a channel, the pixel circuits comprise first pixel circuits and second pixel circuits, the first pixel circuits and the second pixel circuits are alternately arranged along a row direction, the first pixel circuits and the second pixel circuits are alternately arranged along a column direction, and channels of at least two transistors in a first pixel circuit of the first pixel circuits and channels of at least two transistors in a second pixel circuit of the second pixel circuits are mirror-symmetric with respect to the column direction, wherein the row direction intersects with the column direction;
a plurality of light-emitting elements, wherein the plurality of light-emitting elements comprise first color light-emitting elements, second color light-emitting elements, and third color light-emitting elements with different emission colors;
a plurality of repeating units arranged in an array, wherein a repeating unit of the plurality of repeating units comprises a first sub-unit and a second sub-unit arranged along the column direction, the first sub-unit comprises a first color light-emitting element, a second color light-emitting element, a third color light-emitting element, and a second color light-emitting element that are arranged in sequence along the row direction, and the second sub-unit comprises a third color light-emitting element, a second color light-emitting element, a first color light-emitting element, and a second color light-emitting element that are arranged in sequence along the row direction,
wherein the first color light-emitting elements in an i-th column of light-emitting elements are electrically connected to the first pixel circuits in a (j+1)-th column of pixel circuits respectively; and
the first color light-emitting elements in an (i+2)-th column of light-emitting elements are electrically connected to the first pixel circuits in a (j+2)-th column of pixel circuits respectively.
